(19) United States
(12) Patent Application Publication
(10) Pub. No.: US 2013/0070911 A1
(43) Pub. Date: Mar. 21, 2013

(54) Adaptive Accent Vocie Communications System (AAVCS)

(71) Applicant: Daniel O'Sullivan, Southold, NY (US)

(72) Inventor: Daniel O'Sullivan, Southold, NY (US)

(21) Appl. No.: 11/781,255

(22) Filed: Jul. 22, 2007

(51) Int. Cl. H04M 1/64

(52) U.S. Cl. CPC H04M 1/645
USPC 379/88.04

(57) ABSTRACT

This invention allows a Voice System to adapt to the speaking accent of the user. This means that users of the system would automatically hear the voice messages played by the Voice System in the same accent that they are likely to be speaking in. The purpose of the invention is to permit more fluid, productive, user friendly and shorter interactions with IVR and other Voice Systems.

### CROSS-REFERENCE TO RELATED APPLICATIONS

This application for letters patent is a continuation of provisional patents for VoiceXL for VXML and VoiceXL for Processors applications filed on Aug. 25, 2004, Multimodal VoiceXL filed on Aug. 4, 2003, VoiceXL Provisional Patent Application filed on May 20, 2003, Easytalk Provisional Patent Application filed on May 9, 2001 and U.S. Pat. No. 5,493,608.

### STATEMENT REGARDING FEDERALLY SPONSORED RESEARCH OR DEVELOPMENT

Not Applicable.

### FIELD OF THE INVENTION

This invention pertains to information dissemination systems, and particularly to interactive voice response systems wherein users communicate with a computer over conventional telephone lines.

### BACKGROUND

This invention is a modification to my U.S. Pat. No. 5,493,608 for a caller adaptive voice response system (CAVRS).

It is the nature of many businesses that they receive many telephone inquiries from customers, potential customers and other businesses. Obviously, if each call is answered by an operator, a sufficient number of operators must be available to answer calls as they are received. The expense of doing this is obvious. Moreover, almost invariably there are peak times when the number of callers exceeds the number of operators. When this happens, many of the calls must be queued. The queue time can often become so long that many callers will hang up in frustration, perhaps never to call again. This results in a significant loss of business and corporate image.

A further problem with operators is that many of today's callers would rather not deal with other people when they have a choice to also use an automated system. As evidenced by the recent popularity of automated teller machines, people often prefer to transact business with a machine at their own pace rather than with a human operator.

Recognizing these problems, others have proposed voice announcement systems wherein a caller accesses a single pre-recorded message. The caller dials a telephone number specific to that service, listens to the message and then hangs up or is disconnected. Examples of these systems include sports information and lottery number pay per call services. Yet others have proposed voice response systems wherein the caller interacts with the system by either pressing the telephone Touch-Tone (a registered trademark of AT&T)” keys or speaking directly into the telephone mouthpiece in response to voice message prompts. Typical examples of these are stock quote systems, transit information systems, call routing systems, local weather and news systems. Certain voice response systems will allow a caller to leave a voice message for a particular party. These are known as voice mail and voice messaging systems.

Known voice response systems all operate by prompting the caller with a voice message prompt spoken by the system instructing the caller to enter either a single touch-tone, multiple touch-tones or to speak a response. Once the voice response system has prompted the caller with a voice message prompt, it then waits a pre-determined amount of time to allow the caller to respond. This is generally on the order of three to five seconds. If the caller responds within the set response time period, the voice response systems application program proceeds to the next level by prompting the caller with the next voice message prompt in the application dialogue. This process is repeated until the caller receives the information he or she wants, hangs up or is disconnected by the voice response system.

If a caller makes an error in response to a voice message prompt or does not enter a response within the set response time, the voice response systems will generally repeat the voice message prompt and ask the caller to try again. If the caller again does not respond within the response time, the voice response system will generally forward the caller to an operator for assistance.

All stored voice messages for known voice response systems use Text-To-Speech encoding algorithms or are recorded off line either by the voice response systems itself or by another voice response system. This is generally done by recording the human voice as it speaks the content of each voice message to be used in the application. The speaking accent for each voice message is recorded is generally set to a generic context to suit a majority of callers. Most importantly, all voice messages on known voice response systems are recorded and played back to the caller in a preselected, fixed accent for each speaking language supported by the system.

It is only in the last few years that the voice communications industry has focused its attention on improved VUI Design, Adaptive Caller Interfaces and User Personalization.

### BRIEF SUMMARY OF THE INVENTION

This invention allows a Voice System to adapt to the speaking accent of the user. This would mean that users of the system would automatically hear the voice messages played by the Voice System in the same accent that they are likely to be speaking in. The purpose of the invention is to permit more fluid, productive, user friendly and shorter interactions with IVR and other Voice Systems.

### DETAILED DESCRIPTION OF THE INVENTION

Broadly speaking, the invention comprises a hardware and software based interactive voice response system that adapts to the speaking accent of the caller. The caller interacts with the system utilizing the keypad buttons on a DTMF-type telephone or by speaking verbal instructions over any type of telephone, and hears spoken instructions and information over the telephone in response to those entries.

The system is capable of being programmed to execute any voice response system application dialogue including but not limited to voice mail, call attendant, entertainment and travel information, order inquiry, financial and brokerage information, news, weather and sports information. In fact, any voice response systems that elicits a response from the caller can benefit from the caller adaptive response algorithm.

The adaptive accent voice communications system is actually a conventional voice response system which is programmed to respond in the accent likely being used by the user.

A first object of this invention is to reduce telecommunications costs associated with unduly long call duration times of conventional voice response systems.

A second object of the present invention is to reduce the amount of voice response system hardware it takes to handle a given number of telephone calls in a given time period. Or, if desired, the same number of telephone calls can be handled with fewer telephone lines and less voice response system hardware. This results in significant cost savings in both recurring telephone line charges and one time voice response systems equipment charges.

A third object of the present invention is to promote caller usage of a particular voice response system application. Since the adaptive accent voice communications system automatically matches or closely approximates the speaking accent of the caller, the caller will feel more comfortable than with a voice response system that responds in kind.

The system is capable of being programmed to execute any voice response system application dialogue including but not limited to voice mail, call attendant, entertainment and travel information, order inquiry, financial and brokerage information, news, weather and sports information.

The various features of novelty which characterize the invention are pointed out with particularity in the claims annexed to and forming a part of the disclosure. For a better understanding of the invention, its operating advantages, and specific object attained by its use, reference should be had to the drawing and descriptive matter in which there are illustrated and described preferred embodiments of the invention.

The invention is not limited by the embodiments described above which are presented as examples only but can be modified in various ways within the scope of protection defined by the appended patent claims.

1.-4. (canceled)

5. A system, comprising:
a memory configured to store a plurality of voice recordings, the plurality of voice recordings including at least one phrase, the phrase being recorded in a plurality of accents;
an identification module configured to select a voice recording associated with an accent from the plurality of accents, the identification module configured to select the voice recording based on a trigger; and
a voice prompt module configured to output the selected voice recording.

6. The system of claim 5, wherein the identification module is configured to receive Automatic Number Identification (ANI) associated with a caller, the ANI being the trigger to select a particular voice recording, such that an accent from the plurality of accents is output based on the ANI.

7. The system of claim 6, wherein the ANI includes at least one of an area code or a country code.

8. The system of claim 5, wherein the identification module is configured to receive spoken responses from a caller in response to a calibration question, the spoken responses being the trigger to select a particular voice recording, such that an accent from the plurality of accents is output based on the spoken responses.

9. The system of claim 5, wherein the identification module identifies an accent associated with a caller and selects the voice recording based on the identification.

10. The system of claim 5, wherein the trigger is received from a user interface device, the user interface device being one of a computer or a phone.

11. A method, comprising:
receiving a call from a caller to a voice response system;
identifying an accent associated with the caller;
selecting from a memory, based on the identifying, a recording of a spoken voice prompt in an accent from a plurality of recordings of the spoken voice prompt in a plurality of accents; and
outputting the recording in the accent to the caller.

12. The method of claim 11, wherein the identifying includes identifying the accent associated with the caller based on an Automatic Number Identification (ANI) associated with the call.

13. The method of claim 12, wherein the ANI includes at least one of an area code or a country code.

14. The method of claim 12, wherein the identifying includes receiving spoken responses from the caller to at least one calibration question.
